(19) United States
(12) Patent Application Publication
(10) Pub. No.: US 2004/0104086 A1
(43) Pub. Date: Jun. 3, 2004

(54) Disk brake assemblies having springs for biasing friction pads

(75) Inventor: Yoshiyuki Katoh, Aichi-ken (JP)

Correspondence Address: BURNS DOANE SWECKER & MATHIS L L P, POST OFFICE BOX 1404, ALEXANDRIA, VA, 22313-1404, US

(73) Assignee: ADVICS CO., LTD.

(21) Appl. No.: 10/721,233

(22) Filed: Nov. 26, 2003

(30) Foreign Application Priority Data
Nov. 28, 2002 (JP) 2002-346394

(51) Int. Cl. F16D 65/40

(52) U.S. Cl. 188/73.38

(57) ABSTRACT

A disk brake assembly including a disk rotor, a pair of friction pads adapted to be pressed against the disk rotor from either side in the axial direction of the disk rotor, and at least one return spring coupled to the friction pads in order to bias the friction pads in directions away from the braking surface of the disk rotor. The return spring includes a straddle portion, a pair of extensions, and a pair of engaging portions. Each of the extensions extends from the straddle portion to an engaging position that is proximate to a radial centerline of the friction pads. Each of the engaging portions is disposed at one end of each extension and engages one of the friction pads at engaging positions located on either end of the length of the friction pad.

This application claims priority to Japanese patent application serial number 2002-346394, the contents of which are incorporated herein by reference.

### BACKGROUND OF THE INVENTION

1. Technical Field

The present invention relates to disk brake assemblies, such as vehicle brake assemblies for applying braking forces to wheels of automobiles.

2. Description of the Related Art

Japanese Laid-Open Patent Publication No. 4-175523 teaches a known disk brake assembly that includes a pair of friction pads and a return spring for the friction pads. The friction pads are adapted to be pressed against a brake disk. The return spring serves to bias the friction pads in directions away from each other and away from the brake disk. The return spring is formed by bending a wire spring and includes a straddle portion and engaging portions. The straddle portion is disposed adjacent the outer periphery of the brake disk so as to straddle the outer diameter of the brake disk in the axial direction of the brake disk. The engaging portions are adapted to be engaged with the respective friction pads. More specifically, the engaging portions are inserted into engaging holes formed in respective outer peripheral end surfaces of the friction pads.

However, with the known disk brake spring biasing assembly the outer peripheral end surfaces of the friction pads receive the majority of the biasing force from the return spring, while the inner peripheral end surfaces of the friction pads may not receive sufficient biasing force. Therefore, it is very likely that the returning movement distance of the inner peripheral end surfaces of the friction pads is different than the returning movement distance of the outer peripheral end surfaces. In other words, the unbalanced forced caused by the known disk brake spring biasing assembly results in the friction pads potentially being unable to fully return to their original positions. The friction pads are likely to be placed at an angle to the surface of the brake disk resulting in an intermittent audible squeal produced by the friction pads unintentionally rubbing against the brake disk.

### SUMMARY OF THE INVENTION

It is accordingly an object of the present invention to teach improved techniques for enabling brake pads to uniformly move away or retract from each other with respect to the radial direction of a brake disk.

According to one aspect of the present teachings, disk brake assemblies are taught that include a disk rotor having a central axis, a pair of friction pads adapted to be pressed against the disk rotor from either side along the axial direction of the disk rotor, and at least one return spring coupled to the friction pads in order to bias the friction pads in a direction away from the disk rotor. The return spring includes a straddle portion, a pair of extensions, and a pair of engaging portions. The straddle portion is disposed radially beyond the external diameter of the disk rotor and extends across the thickness of the disk rotor in the axial direction in order to straddle both sides of the disk rotor. Each of the extensions extends from the straddle portion, in a direction substantially toward the central axis of the disk rotor, to an engaging position that is proximal to a centerline (with respect to the radial direction of the disk rotor) of a friction pad. Each of the engaging portions is disposed at one end of each extension and subsequently engages one of the friction pads at the engaging position. Throughout the specification, the terms “central axis”, “axial direction”, “radial direction,” and “circumferential direction.” are used to indicate the axis and directions with regard to the disk rotor, unless specifically noted otherwise.

Because, the return spring engages at the engaging position that is proximal to the centerline (with respect to the radial direction of the disk rotor) of one of the friction pads, the biasing force of the return spring is predominately applied to a central location of the friction pads. Therefore, the friction pads may be more uniformly moved by the return spring. In other words, the returning movement distance of the radially outward portion of each friction pad becomes substantially equal to the returning movement distance of the radially inward portion. As a result, the friction pads may maintain a more generally parallel relationship with the braking surfaces of the disk rotor during the returning movement than possible with an unbalanced return force.

According to another aspect of the present teachings, the disk brake assemblies further include a mount that serves to support the friction pads. The mount is designed and constructed so that the friction pads may move relative to the mount.

According to an additional aspect of the present teachings, each of the extensions of the return spring extends from the straddle portion to the engaging position through gaps provided between the mount and the end portions of both sides of the friction pads (with respect to the circumferential direction of the disk rotor).

Such a gap between a mount and an end portion of each friction pad is generally provided in existing disk brake assemblies. Therefore, in some embodiments, no additional device or structure is required or modified in order to accommodate the return biasing springs. An existing gap is utilized as a pathway for each extension allowing the return biasing spring to engage the end portions of the friction pads. As a result, simplifying the overall construction of the disk brake assemblies incorporating a return spring biasing force.

According to a further aspect of the present teachings, the disk brake assemblies further include a slide guide device. The slide guide device has a first guide portion provided on the mount and a second guide portion provided on each of the friction pads, so that the second guide portion can slide relative to the first guide portion. For example, the first guide portion is a recess formed in the mount and the second guide portion is a projection formed on the friction pad. The second guide portion is disposed at the engaging position. Each of the engaging portions of the return spring engages the second guide portion.

Therefore, each friction pad receives the biasing force of the return spring at the engaging portion via the second guide portion. In addition, each of the engaging portions engages the friction pad via the second guide portion. Therefore, in this and some other embodiments, no additional device or structure is required or modified in order to engage the friction pads by the engaging portions. As a result, the construction of the disk brake assemblies can also be simplified in this respect.

According to a further aspect of the present teachings, each of the friction pads includes a friction member and a back plate that serves to support the friction member from a rear side of the friction member. The second guide portions are disposed on each end of the back plate with respect to a circumferential direction of the disk rotor. The affect of the second guide portions is to increase the overall length of the back plate in primarily the circumferential direction. Each of the extensions of the return spring includes a pressing portion arranged and constructed to engage the second guide portion so as to apply a force against at least one of the friction pads in order to bias the friction pads away from the disk rotor. The pressing portion extends mainly in the radial direction with respect to the disk rotor and is positioned between the second guide portion and the disk rotor

Therefore, the pressing portion engages the second guide portion along a length primarily in the radial direction. In addition, because the second guide portion is normally positioned proximally to the centerline of the length of the friction pad, the return spring can apply a force to the friction pad at this position. In other words, the pressing force is applied to the friction pad at a position proximate to the central line and along a length mainly in the radial direction. For this reason, the substantially balanced force causes the returning movements or distances of each friction pad to become substantially uniform along the radial direction. As a result, the friction pads can more closely maintain a parallel relationship with the braking surface of the disk rotor during the returning movement. The overall result is that the friction pads can uniformly move away from the braking surface of the disk rotor.

According to a further aspect of the present teachings, each of the friction pads includes a friction member and a back plate that serves to support the friction member from a rear side of the friction member. The second guide portion is disposed on each end of the back plate with respect to a circumferential direction of the disk rotor and extends outward from the ends of the back plate in the circumferential direction. Each of the engaging portions of the return spring is configured so as to be turned back, generally away from the center axis, to conform to the configuration of a radially inner or lower edge, with respect to the disk rotor, of the second guide portion.

Because the engaging portions are turned back in order to engage the second guide portion, the return spring can be inhibited from being removed from the friction pads by solely bending the return spring in a direction toward the braking surface of the disk rotor. In addition, because the engaging portion is configured to conform to the overall shape of the radially inner edge of the second guide portion, the engaging portion can reliably and securely engage the friction pad.

According to a further aspect of the present teachings, the straddle portion of the return spring includes at least one spirally wound portion. This allows the spring force of the return spring to be adjusted by varying the size and/or the number of turns of the spirally wound portion. The spirally wound portion also serves to facilitate resilient deformation of the straddle portion in primarily the axial direction of the disk rotor. In one example described later, the straddle portion includes a plurality of spirally wounded portions that are arranged along the length of the straddle portion.

Therefore, the effective spring length or the spring force of the return spring can be suitably adjusted by appropriately setting the size and/or the number of turns of the spirally wound portion. In addition, because the resilient deformation of the straddle portion is facilitated, the resilient deformation of the remaining parts of the return spring, i.e., the extensions and the engaging portions, can be reduced or minimized. Localizing the resilient deformations can also result in more predictable life estimates and increases in overall reliability of the return spring.

As a result of the spirally wound portion, the engaging portions can more reliably engage the friction pads. In addition, because the extensions as well as their pressing portions are better able to maintain their original orientations without being inclined relative to the braking surface of the disk rotor during the returning movement of the friction pads, the friction pads themselves can also better maintain a parallel relationship with the braking surface of the disk rotor. Therefore, the friction pads can more easily uniformly move away from the braking surface of the disk rotor.

The at least one spirally wound portion may be functionally replaced with at least one fold of the straddle portion. With this arrangement, the same advantages as with the at least one spirally wound portion can also be attained.

### BRIEF DESCRIPTION OF THE DRAWINGS

Additional objects, features, and advantages, of the present invention will be readily understood after reading the following detailed description together with the claims and the accompanying drawings, in which:

FIG. 1 is a plan view of a first representative disk brake assembly; and

FIG. 2 is a sectional view taken along line II-II in FIG. 1; and

FIG. 3 is a sectional view taken along line III-III in FIG. 1; and

FIG. 4 is a front view of a return spring of the first representative disk brake assembly; and

FIG. 5 is a front view of a return spring of a second representative disk brake assembly; and

FIG. 6 is a front view of a return spring of a third representative disk brake assembly; and

FIG. 7 is a perspective view of a return spring of a fourth representative disk brake assembly; and

FIG. 8 is a sectional view, similar to FIG. 4, of the fourth representative disk brake assembly; and

FIG. 9 is a perspective view of a return spring of a fifth representative disk brake assembly; and

FIG. 10 is a sectional view, similar to FIG. 2, of the fifth representative disk brake assembly; and

FIG. 11 is a plan view of a part of the fifth representative disk brake assembly.

### DETAILED DESCRIPTION OF THE INVENTION

Each of the additional features and teachings disclosed above and below may be utilized separately or in conjunction with other features and teachings to provide improved disk brake assemblies and methods of manufacturing and using such disk brake assemblies. Representative examples of the present invention, which examples utilize many of these additional features and teachings both separately and in conjunction with other features, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

First Representative Embodiment

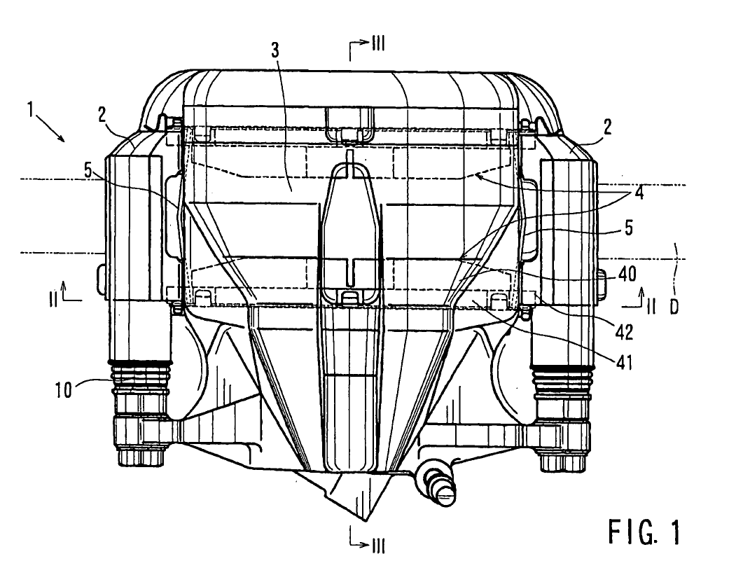

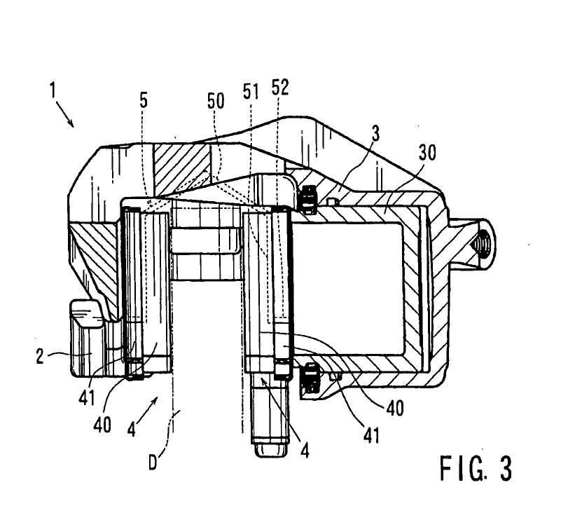

A first representative embodiment will now be described with reference to FIGS. 1 to 4, which shows a first representative disk brake assembly 1 that is adapted to be mounted to a vehicle body (not shown) of a wheeled vehicle, such as an automobile. The disk brake assembly 1 generally includes a pair of friction pads 4, a caliper 3 and a pair of mounts 2. The friction pads 4 are designed to engage the braking surfaces of a disk rotor D that rotates together with a wheel, such as a vehicle wheel of an automobile (not shown). As shown in FIG. 3, a hydraulic cylinder 30 is mounted within the caliper 3 and serves to apply a force to the friction pads 4. The force results in the friction pads 4 frictionally pressing against both braking surfaces of the disk rotor D. The caliper 3 is supported on the mount 2. The disk brake assembly 1 further includes a pair of return springs 5 that are disposed on both sides of the disk brake assembly 1 and extend beyond the outer circumference of the disk rotor D. The return springs 5 serve to bias the friction pads 4 in directions away from each other and subsequently away from the braking surfaces of the disk rotor D.

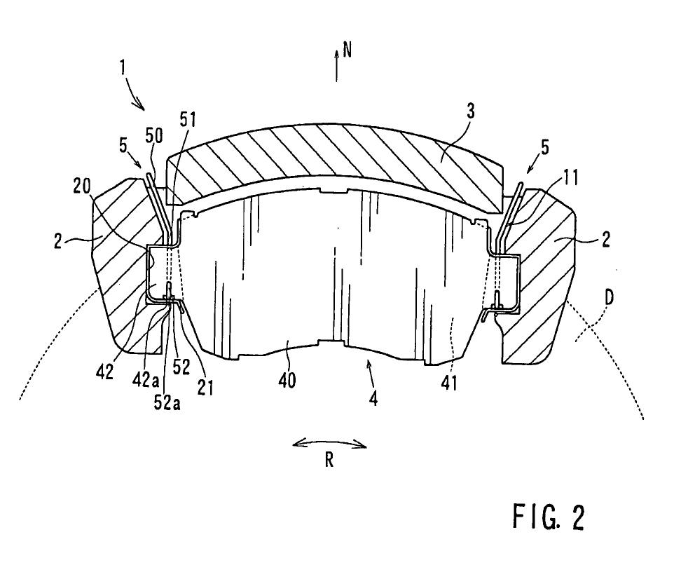

The mounts 2 are fixedly mounted to the vehicle body. Mounts 2 serve to slidably and movably support caliper 3 and friction pads 4. As shown in FIG. 2, a guide recess 20 is formed in each mount 2 and serves to provide a guide for orienting the corresponding friction pad 4 in a direction substantially parallel to the axial direction of the disk rotor D (a direction perpendicular to the sheet of FIG. 2). The guide recess 20 has a depth that extends from an inner surface of each mount 2. The inner surface of each mount 2 directly opposes the corresponding friction pad 4. The guide recess 20 extends below the inner surface of each mount 2 toward the outer surface of each mount 2 in a substantially circumferential direction of the disk rotor D (as indicated by an arrow R in FIG. 2). In addition, the guide recess 20 has a length in a direction primarily parallel to the axial direction of the disk rotor D (the direction perpendicular to the sheet of FIG. 2), to allow for movement, toward and away from the braking surfaces of the disk rotor D, by the friction pads 4 throughout the range of wear of the friction pads 4. Further, the guide recess 20 slidably receives guide projections 42 provided on each side of each friction pad 4 in the substantially circumferential direction R of the disk rotor D.

The caliper 3 with the hydraulic cylinder 30 mounted therein is slidably supported by the mounts 2 via slide members 10, i.e., slide pins, so that the caliper 3 can slidably move in parallel to the axial direction of the disk rotor D.

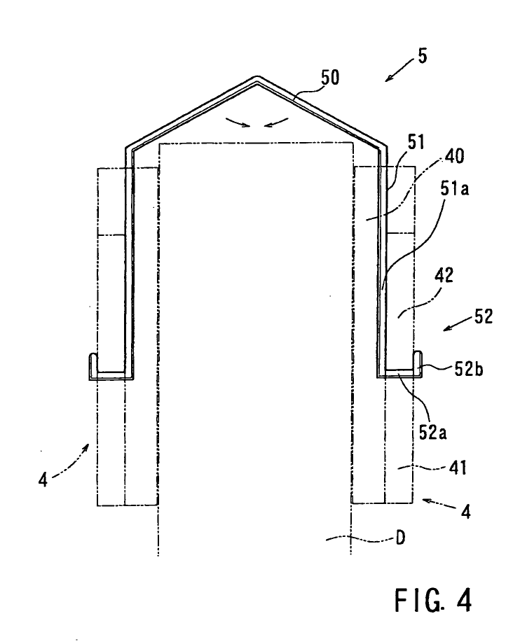

Referring to FIGS. 3 and 4, each of the friction pads 4 includes a friction member 40 and a back plate 41. The friction member 40 is adapted to engage the braking surface of the disk rotor D in order to produce a frictional force inhibiting rotation of the disk rotor D. The back plate 41 supports the rear side of the frictional member 40.

Referring to FIG. 2, the guide projections 42 are disposed on either side of the length of rear plate 41 in the substantially circumferential direction R. More specifically, the guide projections 42 serve to extend the overall length of the rear plate 41 in the substantially circumferential direction R. The guide projections 42 are inserted into the corresponding guide recesses 20 of the mount 2 so as to be slidably supported by the mount 2. As a result, the corresponding guide recesses 20 in the axial direction of the disk rotor D slidably guide the guide projections 42.

As shown in FIG. 2, the guide projections 42 in this example are substantially positioned along the centerline of the rear plate 41 in a radial direction N shown. However, the guide projections 42 may be located at other positions along the rear plate 41. Each of the guide projections 42 extends in the radial direction N along a length so as to substantially include the centerline position of the rear plate 41 in the radial direction.

Further, as shown in FIG. 2, a metal support member 21 is attached to each guide projection 42 and has a configuration substantially conforming to the external configuration of the guide projection 42. The support member 21 is interposed between the guide projection 42 and an inner wall of the corresponding guide recess 20 of the mount 2. As a result, the friction pad 4 is restricted from directly contacting the mount 2, thereby reducing the occurrence of localized areas of high coefficients of friction (possibly resulting in intermittent sticking between the friction pad 4 and the mount 2) caused by rust produced during the lifetime of brake operation.

Referring to FIG. 4, each of the return springs 5 is made of wire and includes a straddle portion 50, a pair of extensions 51, and a pair of engaging portions 52. As shown in FIG. 3, the straddle portion 50 extends so as to straddle both sides of the disk rotor D in the axial direction beyond the outer periphery of the disk rotor D. The extensions 51 extend from both ends of the straddle portion 50 substantially toward the central axis of the disk rotor D. The engaging portions 52 are disposed at the lower ends (closest to the central axis) of the respective extensions 51 and are adapted to engage the corresponding friction pads 4.

As shown in FIG. 4, the straddle portion 50 of this embodiment is configured to have an angular configuration so that the distance between the straddle portion 50 and the outer periphery of the disk rotor D increases toward the center of the thickness of the disk rotor D in the axial direction. As a result, the straddle portion 50 may not contact the disk rotor D. In addition, because the straddle portion 50 is bent or folded at the central position along the axial direction regarding the thickness of disk rotor D, the straddle portion 50 can be readily resiliently deformed about the bent portion. The bent portion shown may be angled or curved with a small radius of curvature.

As shown in FIG. 2, each of the extensions 51 extends substantially toward the central axis of the disk rotor D from a position proximate to the outer circumference of the disk rotor D to a position slightly below the centerline (in the radial direction of the disk rotor D) of the corresponding friction pad 4. More specifically, each of the extensions 51 extends along the outer surface (in substantially the circumferential direction R) of the corresponding friction pad 4 through a gap 11 that is formed between the outer surface of the corresponding friction pad 4 and the inner surface of mount 2, and across projections 42. Subsequently, each of the extensions 51 reaches a position proximate to the center Cm the radial direction of the disk rotor D) of the corresponding friction pad 4.

As shown in FIG. 4, each of the extensions 51 extends in the radial direction of the disk rotor D through a space in the axial direction provided between the corresponding guide projection 42 and the disk rotor D. Each of the extensions 51 has a pressing portion 51a that contacts a surface (the surface of guide projection 42 directly opposing the disk rotor D) of the corresponding guide projection 42 and extends in the radial direction substantially toward the center of the disk rotor D.

Therefore, the pressing portion 51a of each of the extensions 51 of the return spring 5 serves to bias the friction pad 4 via the corresponding guide projection 42 in a direction away from the braking surfaces of disk rotor D. In addition, because the pressing portion 51a extends along the corresponding guide projection 42 in the radial direction of the disk rotor D, the biasing force can be applied to essentially the entire length of the corresponding guide projection 42.

As a result, the friction pads 4 are biased to move away from each other by the return spring 5 via the guide projections 42. In addition, because the biasing forces are applied to essentially the entire length of the guide projections 42, the biasing forces are applied to the friction pads 4 at substantially the centerline portions thereof (in the radial direction of the disk rotor D).

According to this arrangement, the movement of each friction pad 4, from a position of engagement with the braking surface of disk rotor D to a position away from the braking surface of disk rotor D, becomes uniform across the radial direction of the disk rotor D. Each friction pad 4 moves while it maintains a substantially parallel relationship with the braking surface of disk rotor D. The biasing force applied proximate to the centerline of the friction pad 4 allows the friction pad 4 to move without being inclined relative to the braking surface of the disk rotor D. As a result, the friction pads 4 can uniformly move away from the disk rotor D.

The engaging portions 52 of the return spring 5 will now be described. As shown in FIG. 4, each of the engaging portions 52 extends in a u-turn manner back from the lower end of the corresponding extension 51 in a direction substantially away from the center of the disk rotor D. More specifically, each of the engaging portions 52 includes a removal prevention portion 52a and a turn-back portion 52b. The removal prevention portion 52a extends from the lower end of the corresponding extension 51 in the axial direction away from the braking surface of the disk rotor D (rightward or leftward away from the center of the drawing, as viewed in FIG. 4). The turn-back portion 52b extends upward, (as viewed in FIG. 4) back along the same general direction as taken by 51a, from the outer end of the removal prevention portion 52a.

The removal prevention portion 52a extends along a lower edge thickness (closer to the center in the radial direction of the disk rotor D) of the corresponding guide projection 42. The location of removal prevention portion 52a inhibits the unintended movement of the return spring 5 in a radially outward direction (radially away from the center of the disk rotor D).

Referring to FIG. 2, an engaging recess 42a is formed in the lower edge thickness of each of the guide projections 42 and serves to admit the corresponding removal prevention portion 52a of the return spring 5, so that the removal prevention portion 52a does not protrude outward beyond the remaining lower edge of the guide projection 42. As a result of the engaging recess 42a, the removal prevention portion 52a does not interfere with the sliding movement of the guide projection 42 along the corresponding guide recess 20.

The turn-back portion 52b extends along the rear side (on the side surface opposite to the side surface facing the braking surface of disk rotor D) of the corresponding guide projection 42. Therefore, the return spring 5 can be securely engaged by the corresponding guide projection 42.

In the engaged condition, the removal prevention portion 52a is positioned between the lower edge of the corresponding guide projection 42 and the support member 21. Therefore, the removal prevention portion 52a is reliably prevented from being unintentionally removed from the corresponding guide projection 42. The return spring 5 is also reliably inhibited from moving in a direction toward the central axis of the disk rotor D.

As described above, according to the first representative embodiment, each return spring 5 engages the corresponding friction pad 4 at a substantially centerline position of the friction pad 4 (in the radial direction of the disk rotor D). In addition, the friction pad 4 is biased by the return spring 5 at this same position. Therefore, the movement of each friction pad 4, from a position of contact with the braking surface of disk rotor D to a position away from the braking surface of disk rotor D, becomes substantially balanced across the radial direction of the disk rotor D. For example, the radially outermost end of the friction pad 4 (furthest away from the center axis of disk rotor D) moves at approximately the same instant and at the same speed as the movement of the radially inner end of the same friction pad 4 (closest to the center axis of disk rotor D). Therefore, the friction pads 4 may move away from the braking surface of disk rotor D while maintaining a substantially parallel relationship with the braking surface of disk rotor D. As a result, the friction pads 4 can efficiently move away from the disk rotor D without the unintended production of audible squeals.

In addition, according to the first representative embodiment, each friction pad 4 has guide projections 42 disposed substantially about the centerline of the friction pad 4 (with respect to the radial direction of the disk rotor D) that are adapted to engage the respective engaging portions 52 of each return spring 5. Therefore, each friction pad 4 receives the biasing force at substantially a centerline position via the guide projections 42. In addition, because the engaging portions 52 are fully engaged by the respective guide projections 42, the representative disk brake assembly 1 does not require special modifications, structures, or devices, for engaging the return springs 5. This results in the relatively simple construction of the representative disk brake assembly 1.

Further, because the engaging portions 52 of each return spring 5 are bent upon themselves in a turn-back manner in order to be engaged by the radially lower edge thickness of the respective guide projections 42, the return springs 5 can be prevented from being unintentionally removed from the friction pads 4. In addition, this turn-back manner of the engaging portions 52 of each return spring 5 still allows the representative disk brake assembly 1 to have a relatively simple construction.

Also, because the engaging portions 52 extend across the radially lower edge thickness of the respective guide projections, the engaging portions 52 can securely engage the friction pads 4.

Furthermore, because the straddle portion 50 of each return spring 5 is angled at a central portion with respect to the thickness of the disk rotor D, it is likely that the stress will concentrate at this region of the angled portion where the return spring 5 is deformed. Therefore, the straddle portion 50 can be readily resiliently deformed. As a result, the amount of unintended deformation to the various engaging portions 52 may be minimized, allowing the engaging portions 52 to readily engage the friction pads 4.

Furthermore, by virtue of the central angled portion, the straddle portion 50 can be readily and resiliently deformed along an axial direction of the disk rotor D (across the thickness of disk rotor D). Extensions 51 can move while they substantially maintain a parallel relationship with the braking surfaces of disk rotor D. As a result, the pressing portions 51a of the extensions 51 can apply biasing forces evenly to the friction pads 4 without incurring a tilting of the friction pads 4 with respect to the braking surface of disk rotor D common in other known brake biasing return springs.

Second Representative Embodiment

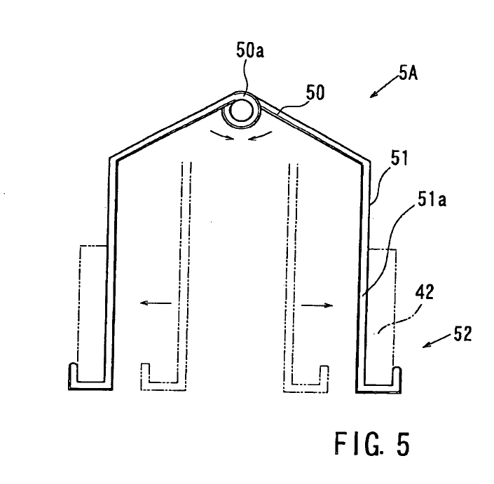

A second representative embodiment will now be described in connection with FIG. 5. The second representative embodiment is a modification of the first representative embodiment and is different only in the configuration of the return springs 5. In most other respects, the second representative embodiment is identical to the first representative embodiment.

One of return springs 5A of the second representative embodiment is shown in FIG. 5, which corresponds to FIG. 4 of the first representative embodiment. In FIG. 5, identical members are given the identical reference numerals as in FIG. 4, and no initial explanation of these members will be repeated.

The return spring 5A shown in FIG. 5 includes the straddle portion 50, a pair of extensions 51, and a pair of engaging portions 52, similar to the return spring 5 of the first representative embodiment. The return spring 5A differs from the return spring 5 primarily in the fact that the return spring 5A includes a spirally wound portion 50a at substantially the central position with respect to the axial direction of the thickness of disk rotor D.

With this particular arrangement, when a force is applied to move the extensions 51 towards each other, the spirally wound portion 50a may be resiliently deformed or twisted to alter the overall diameter of the spiral. Therefore, the length of the straddle portion 50a along an axial direction across the thickness of the disk rotor D may vary in response to a change in the diameter of the spirally wound portion 50a.

In addition, the spirally wound portion 50a may increase the effective spring length of the straddle portion 50 and the overall return spring 5A. Therefore, by suitably altering the diameter and/or the number of turns of the spirally wound portion 50a; the biasing force applied to the friction pads 4 can be adjusted.

Because the spirally wound portion 50a is disposed substantially central to the straddle portion 50 with respect to the axial direction of thickness of the disk rotor D, the straddle portion 50 can readily resiliently deform along the axial direction of the disk rotor D. Therefore, the amount of deformation of the engaging portions 52 can be reduced or minimized. This allows the engaging portions 52 to reliably engage the friction pads 4. In addition, as the straddle portion 50 is resiliently deformed with respect to the axial direction of the thickness of disk rotor D, the extensions 51 can move while they substantially maintain a parallel relationship with the braking surfaces of disk rotor D. As a result, the pressing portions 51a of the extensions 51 can apply biasing forces to the friction pads 4 without necessarily causing tilting of the friction pads 4 with respect to the braking surface of the disk rotor D. As a result, the friction pads 4 can be uniformly moved away from the disk rotor D.

Although the spirally wound portion 50a is wound by one turn in this representative embodiment, the spirally wound portion 50a may also be wound by a plurality of turns. By suitably setting the number of turns of the spirally wound portion 50a, the biasing force applied to the friction pads 4 can also be adjusted.

Third Representative Embodiment

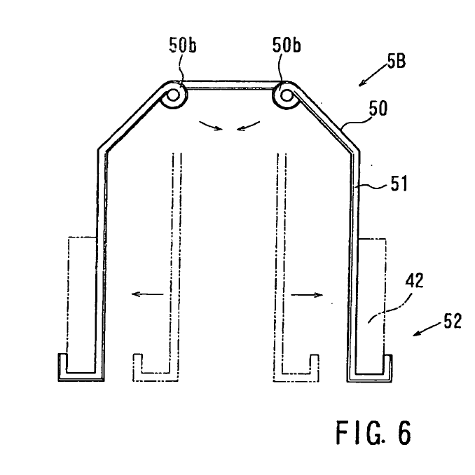

A third representative embodiment will now be described in connection with FIG. 6. As with the second representative embodiment, the third representative embodiment is a modification of the first representative embodiment and is different from the first representative embodiment primarily in the configuration of the return springs 5. In most other respects, the third representative embodiment is identical to the first representative embodiment.

An example of one of the return springs 5B of the third representative embodiment is shown in FIG. 6. FIG. 6 corresponds to FIG. 4 of the first representative embodiment. In FIG. 6, identical members are given the identical reference numerals as in FIG. 4, and no initial explanation of these members will be repeated.

The return spring 5B shown in FIG. 6 includes the straddle portion 50, a pair of extensions 51, and a pair of engaging portions 52, similar to the return spring 5 of the first representative embodiment. The return spring 5B differs from the return spring 5 in the fact that the return spring 5B includes two spirally wound portions 50b that are spaced apart from each other along the axial direction across the thickness of the disk rotor D. The operation of each spirally wound portion 50b is similar to the spirally wound portion 50a of the second representative embodiment. Subsequently, when a force is applied to move the extensions 51 towards each other, the spirally wound portions 50b may be resiliently deformed or twisted to reduce their diameters. Therefore, the length of the straddle portion 50a, along the axial direction of the disk rotor D, may vary in response to the change in the diameters of the spirally wound portions 50b. In addition, the biasing force applied to the friction pads 4 can be adjusted by suitably altering the number and size of the turns of the spirally wound portions 50b.

As a result, the third representative embodiment can provide essentially the same advantages as the second representative embodiment. In addition, although two spirally wound portions 50b are provided in the third representative embodiment, three or more spirally wound portions 50b may be provided. The biasing force applied to the friction pads 4 can also be adjusted by suitably setting the number of the spirally wound portions 50b.

Fourth Representative Embodiment

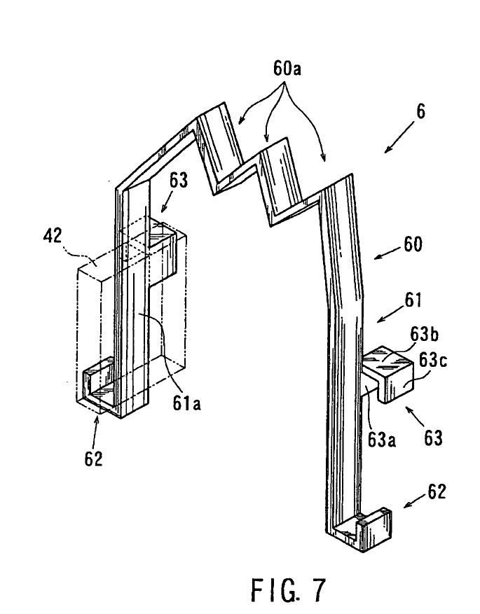

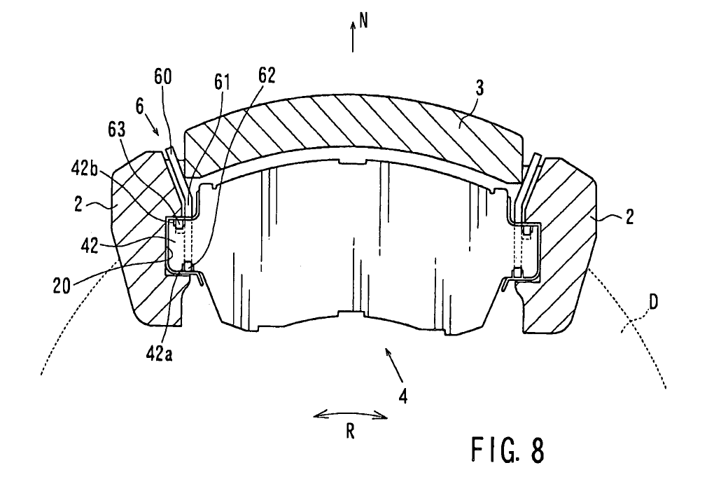

A fourth representative embodiment will now be described in connection with FIG. 7 and FIG. 8. The fourth representative embodiment is again a modification of the first representative embodiment. The fourth representative embodiment differs from the first representative embodiment only in the configuration of the return springs 5 and the related configuration of the guide projections 42. In most other respects, the fourth representative embodiment is the same as the first representative embodiment. In FIG. 7 and FIG. 8, identical members are given the identical reference numerals as in FIG. 1 to FIG. 4, and no initial explanation of these members will be repeated.

An example of one of return springs 6 of the fourth representative embodiment is shown in FIG. 7. The return spring 6 is made of spring plate and includes a straddle portion 60, a pair of extensions 61, and a set of engaging portions including a pair of first engaging portions 62 and a pair of second engaging portions 63. The first engaging portions 62 are adapted to engage the radially lower (inner) edges of the thickness of the projections 42 of the friction pads 4 and the second engaging portions 63 are adapted to engage the radially higher (outer) edges of the thickness of the projections 42 of the friction pads 4.

The straddle portion 60 extends to straddle the disk rotor D in the axial direction across the thickness of the disk rotor D, beyond the outer periphery of the disk rotor D. As shown in FIG. 7, the straddle portion 60 has a plurality of folds 60a that are formed by bending, deforming, or folding back the straddle portion 60 for a plurality of times. In this representative embodiment, five folds 60a are provided, including three oriented upward and two oriented downward.

The folds 60a are positioned substantially across the center of the straddle portion 60. Due to the folds 60a, the straddle portion 60 can resiliently deform as the folding angle of the folds 60a is resiliently changed. In addition, the length of the straddle portion 60 in the axial direction across the thickness of the disk rotor D varies with the changing of the folding angles of the folds 60a.

As shown in FIG. 8, each of the extensions 61 extends from the straddle portion 60 to a position proximate to the centerline of the corresponding friction pad 4 (with regard to the radial direction of the disk rotor D). In addition, as shown in FIG. 7, each of the extensions 61 has a pressing portion 61a that is adapted to engage in a substantially surface-to-surface contact relationship with the surface of the corresponding guide projections 42 positioned directly opposite to the braking surfaces of the disk rotor D.

Each of the first engaging portions 62 is disposed at the lower end of the corresponding extension 61 and is bent in a turn-back manner so as to engage the radially lower edge thickness of the corresponding guide projection 42.

On the other hand, each of the second engaging portions 63 is disposed at approximately the middle position of the length of the corresponding extension 61. The second engaging portion 63 includes a protruding portion 63a, a covering portion 63b, and a hook portion 63c. The protruding portions 63a extends from the extension 61 in the circumferential direction of the disk rotor D along the axially inner surface of the corresponding guide projection 42. The covering portion 63b extends from the radially outward edge (upper edge as viewed in FIG. 7) of the protruding portion 63a in the axial direction of the disk rotor so as to cover the radially outer edge thickness of the guide projection 42. The hook portion 63c extends from the covering portion 63b along the rear surface of the guide projection 42 (the other side surface not directly opposite the braking surface of disk rotor D). With this configuration, the second engaging portion 63 engages the radially outer edge thickness of the guide projection 42.

The return spring 6 is prevented from being unintentionally moved from the friction pads 4 in the radially outward direction N (see FIG. 8) away from the center axis of the disk rotor D. In particular, the first engaging portions 62 serve to prevent the return spring 6 from being removed from the friction pads 4 in the radially outward direction N and the second engaging portions 63 serve to prevent the return spring 6 from being unintentionally moved from the friction pads 4 in the radially inward direction towards the center axis of the disk rotor D.

In addition, as shown in FIG. 8, each of the first engaging portions 62 is partly received within the recess 42a formed in the radially inward (lower) edge of the corresponding guide projection 42 in the same manner as the engaging portion 52 of the first representative embodiment. In addition, each of the second engaging portions 63 is partly received within a recess 42b formed in the radially outer (higher) edge of the corresponding guide projection 42. Therefore, the first engaging portions 62 and the second engaging portions 63 may not protrude downward and upward beyond the radially inward edge and the radially outward edge of the guide projections 42, respectively. Therefore, the first and second engaging portions 62 and 63 may not cause excessive interference with the slide movement of the friction pads 4.

According to the fourth representative embodiment, the effective spring length of the return springs 6 can be adjusted by the number and/or size of the folds 60a. In addition, the folds 60a are advantageous, because they readily facilitate the resilient deformation of the length of the straddle portion 60.

Also in the fourth representative embodiment, the amount of deformation of the engaging portions 62 can be reduced or minimized, so that the engaging portions 62 can reliably engage the friction pads 4. In addition, as the straddle portion 60 is resiliently deformed with respect to the axial direction across the thickness of the disk rotor D, the extensions 61 can move while substantially maintaining a parallel relationship with the disk rotor D. As a result, the pressing portions 61a of the extensions 61 can apply balanced biasing forces to the friction pads 4 without causing excessive tilting of the friction pads 4 with respect to the braking surface of the disk rotor D. Therefore, the friction pads 4 can uniformly move away from the disk rotor D.

As noted above, the number of the folds 60a may not be identical to the five as described in the embodiment shown in FIG. 7. For example, the straddle portion 60 may have two upwardly oriented folds and three downwardly oriented folds. In another example, the straddle portion 60 may have seven or more folds including four or more upwardly oriented folds.

Further, according to the fourth representative embodiment, in addition to the pressing portion 61a, the protruding portion 63a may also contact with the corresponding surface of the guide projection 42. Therefore, the protruding portion 63a also may serve to apply a portion of the pressing force against the guide projection 42. As a result, the friction pads 4 can readily move away from the braking surface of the disk rotor D by the force of the return spring 6 acting via the pressing portion 61a and the protruding portion 63a.

Fifth Representative Embodiment

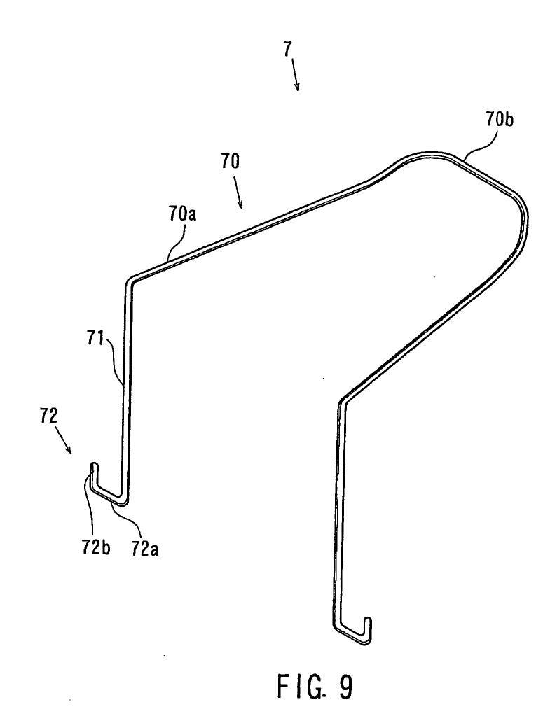

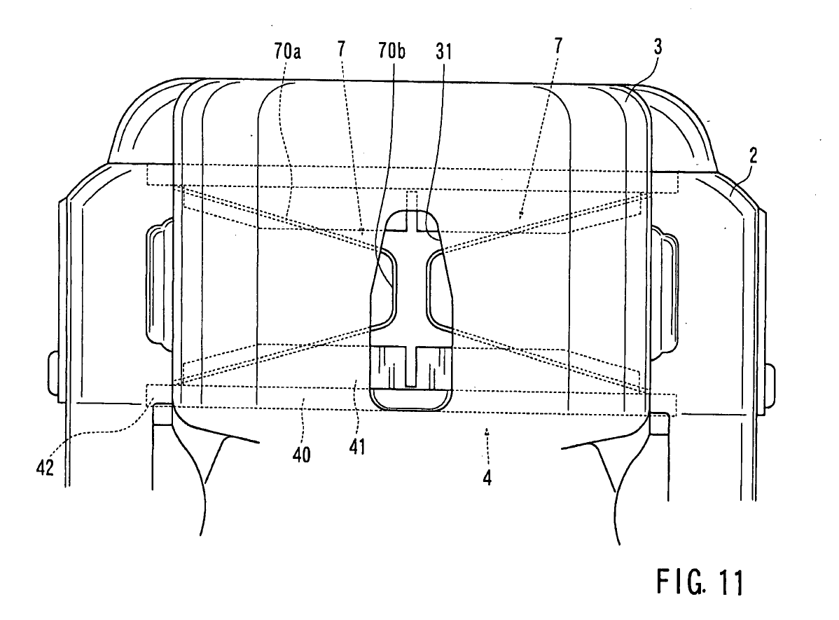

A fifth representative embodiment will now be described in connection with FIG. 9 to FIG. 11. The fifth representative embodiment is a modification of the first representative embodiment and is different from the first representative embodiment primarily in the configuration of the return springs 5. In other respects, the fifth representative embodiment is the same as the first representative embodiment. In FIG. 9 to FIG. 11, identical members are given the identical reference numerals as in FIG. 1 to FIG. 4, and no initial explanation of these members will be repeated.

An example of one of return springs 7 of the fifth representative embodiment is shown in FIG. 9. The return spring 7 is made of spring wire and includes a straddle portion 70, a pair of extensions 71, and a pair of engaging portions 72.

The straddle portion 70 has a pair of circumferentially extending portions 70a and an axially extending portion 70b. Each of the circumferentially extending portions 70a extends from the corresponding extension 71 through a gap 12 defined between the caliper 3 and the radially outermost edge of the corresponding friction pad 4. The circumferentially extending portions 70a continue within the gap to a position proximate to the substantially centerline position of the friction pad 4 with respect to the circumferential direction R of the disk rotor D. The axially extending portion 70b is connected between the front ends (right ends as viewed in FIG. 9) of the circumferentially extending portions 70a and extends in the axial direction across the thickness of the disk rotor D. More specifically, the axially extending portion 70b extends to straddle the disk rotor D, across the thickness of disk rotor D, and beyond the outer periphery of the disk rotor D.

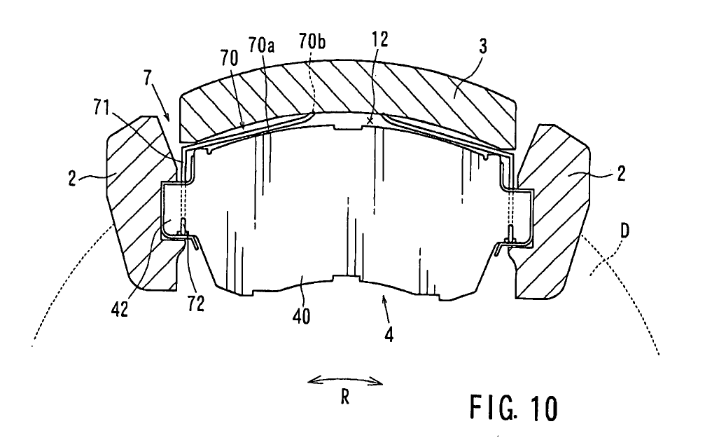

As shown in FIG. 10, each of the front ends of the circumferentially extending portions 70b are bent upward away from the outer periphery of the disk rotor D, so that the axially extending portion 70a may be positioned so as to be seen within a window 31 formed in the caliper 3 as shown in FIG. 1.

The extensions 71 and the engaging portions 72 are the same in construction as the extensions 51 and the engaging portions 72 of the first representative embodiment. Therefore, an explanation of these elements will not be necessary.

According to the fifth representative embodiment, because the circumferentially extending portions 70a of each return spring 7 extends within the space 12 defined between the caliper 3 and the friction pads 4, the circumferentially extending portions 70a may have a length chosen in order to provide the necessary spring force. In addition the effective spring length or the spring force of the return springs 7 can be easily adjusted by changing the length of the circumferentially extending portions 70a as well as by changing the diameter of the spring wire used in forming the return springs 7. Because the circumferentially extending portions 70a are provided to the straddle portion 70, resilient deformation of the straddle portion 70 is facilitated.

Also in the fifth representative embodiment, the amount of deformation of the engaging portions 72 can be reduced or minimized, so that the engaging portions 72 can reliably and securely engage the friction pads 4. In addition, as the straddle portion 70 is resiliently deformed with respect to the axial direction of the disk rotor D, the extensions 71 may move while substantially maintaining a parallel relationship with the braking surface of disk rotor D. As a result, the extensions 71 can evenly apply biasing forces to the friction pads 4 without causing the tilting of the friction pads 4 with respect to the braking surface of the disk rotor D. As a result, the friction pads 4 can uniformly move away from the braking surface of disk rotor D.

Although the guide projections are formed on either sides in the circumferential direction of the friction pads and the guide recesses are formed in the mount in the above representative embodiments, the guide projections may be formed on the mount and the guide recesses may be formed in the friction pads. In such a situation, each of the engaging portions of the return springs may engage an inner wall of the corresponding engaging recess.

What is claimed is:

1. A disk brake assembly comprising:
a disk rotor having a central axis;
a pair of friction pads arranged and constructed to be pressed against the disk rotor from opposing sides in an axial direction of the disk rotor, and
a return spring coupled to the friction pads and arranged and constructed to bias the friction pads in directions away from the disk rotor, wherein:
the return spring includes a straddle portion, a pair of extensions and a pair of engaging portions,
the straddle portion is disposed radially outside of the disk rotor and extends in the axial direction across the thickness of the disk rotor in order to straddle the disk rotor,
each of the extensions extends from the straddle portion, in a direction substantially toward the central axis of the disk rotor, to an engaging position that is proximate to a centerline of one of the friction pads with respect to a radial direction of the disk rotor,
each of the engaging portions is disposed at one end of each extension and engages one of the friction pads at the engaging position.

2. A disk brake assembly as in claim 1, further including:
a mount arranged and constructed to support the friction pads; and
a slide guide device including a first guide portion and a second guide portion provided on the mount and each of the friction pads, so that the second guide portion can slide relative to the first guide portion, wherein:
the second guide portion is disposed at the engaging position; and
each of the engaging portions of the return spring engages the second guide portion.

3. A disk brake assembly as in claim 2, wherein:
each of the friction pads further includes a friction member and a back plate arranged and constructed to support the friction member from a rear side of the friction member;
the second guide portion is disposed on each end of the length of the back plate with respect to a circumferential direction of the disk rotor and extends outward from each end of the back plate in the circumferential direction,
each of the extensions of the return spring includes a pressing portion arranged and constructed to contact the second guide portion so as to apply a pressing force against one of the friction pads in order to bias the friction pads away from the disk rotor,
the pressing portion extends in the radial direction with respect to the disk rotor and is located between the second guide portion and the disk rotor.

4. A disk brake assembly as in claim 3, wherein;
each of the engaging portions of the return spring is further configured to be turned back to conform to the configuration of a radially inner edge, with respect to the disk rotor, of the second guide portion.

5. A disk brake assembly as in claim 4, further including;
second engaging portions disposed on the extensions of the return spring,
wherein each of the second engaging portions of the return spring is configured to be turned back to conform to the configuration of a radially outer edge, with respect to the disk rotor, of the second guide portion.

6. A disk brake assembly as in claim 1, wherein the straddle portion includes one spirally wound portion.

7. A disk brake assembly as in claim 6, wherein the straddle portion includes a plurality of spirally wounded portions that are arranged along the length of the straddle portion.

8. A disk brake assembly as in claim 1, wherein the straddle portion includes one fold disposed in a position substantially centrally of the straddle portion.

9. A disk brake assembly as in claim 8, wherein the straddle portion includes a plurality of folds arranged along the length of the straddle portion.

10. A disk brake assembly as in claim 1, further including a mount arranged and constructed to support the friction pads, so that the friction pads can move relative to the mount, wherein;
each of the extensions of the return spring extends from the straddle portion to the engaging position along of end portions of the friction pads with respect to a circumferential direction of the disk rotor, through a gap provided between the mount and the one of end portions of the friction pads.

11. A disk brake assembly as in claim 1, further including:
a mount arranged and constructed to support the friction pads, so that the friction pads can move relative to the mount, and
a caliper mounted on the mount and disposed radially outside of the friction pads, having a space defined between the caliper and the friction pads in the radial direction of the disk rotor, and
the straddle portion includes a pair of circumferentially extending portions extending from the respective extensions and an axially extending portions connected between the circumferentially extending portions, and
each of the circumferentially extending portions extends in the circumferential direction with respect to the disk rotor, and
the axially extending portion extends in the axial direction with respect to the disk rotor, and
the circumferentially extending portions and the axially extending portion extend within and along the space defined between the caliper and the friction pads.

12. A disk brake assembly comprising:
a disk rotor having a central axis;
a pair of friction pads arranged and constructed to be pressed against the disk rotor from opposite sides in an axial direction of the disk rotor, and
a return spring arranged and constructed to bias the friction pads away from the disk rotor, wherein:
the return spring is coupled to and between the friction pads and has a straddle portion, a pair of extensions, and a pair of joint portions;
the straddle portion is disposed radially outside of the disk rotor and extends in the axial direction of the disk rotor in order to straddle the disk rotor,
each of the extensions has a first end connected to the straddle portion and a second end connected to one of the joint portions,
each of the joint portions is joined to one of the friction pads,
the straddle portion has a resiliently deformable portion so as to provide a biasing force to urge the friction pads away from the disk rotor.

13. A disk brake assembly as in claim 12, wherein the return spring is made of wire spring.

14. A disk brake assembly as in claim 13, wherein the resiliently deformable portion includes at least one spirally wound portion.

15. A disk brake assembly as in claim 14, wherein the resiliently deformable portion includes a plurality of spirally wound portions that are arranged along the length of the straddle portion.

16. A disk brake assembly as in claim 12, wherein the resiliently deformable portion includes an elongated spring plate.

17. A disk brake assembly as in claim 16, wherein the resiliently deformable portion includes at least one fold of the straddle portion.

18. A disk brake assembly as in claim 17, wherein the resiliently deformable portion includes a plurality of folds arranged along the length of the straddle portion.

19. A disk brake assembly as in claim 12, wherein each of the joint portions is joined to one of the friction pads in a position proximal to a central line of the one of the friction pads with respect to a radial direction of the disk rotor.

20. A disk brake assembly as in claim 12, wherein each of the extensions extends along and contacts a surface of one of the friction pads, which surface extends substantially parallel to the disk rotor.
